(19) United States
(12) Patent Application Publication
(10) Pub. No.: US 2015/0188831 A1
(43) Pub. Date: Jul. 2, 2015

(54) System and Method for Traffic Engineering Using Link Buffer Status

(71) Applicant: FUTUREWEI TECHNOLOGIES, INC., Plano, TX (US)

(72) Inventors: Hamid Farmanbar, Ottawa (CA); Hang Zhang, Nepean (CA)

(73) Assignee: FUTUREWEI TECHNOLOGIES, INC., Plano, TX (US)

(21) Appl. No.: 14/146,482

(22) Filed: Jan. 2, 2014

(51) Int. Cl. H04L 12/835; H04L 12/803

(52) U.S. Cl. CPC H04L 47/30; H04L 47/122; H04L 47/125

(57) ABSTRACT

Embodiments are provided for implementing traffic engineering (TE) using link buffer status. The link buffer status for each link is used to identify links with buffer build-ups. One or more of the capacity and resource parameters at the links with buffer build-ups are then reserved. This is achieved by modifying the capacity and resource input parameters to the TE model according to the level of build-ups in the link buffers, as reflected by the buffer status information from the links and nodes. The modified input capacity or resource parameters are then fed to a TE engine to calculate the routing of traffic across all links and paths. As such, the reserved capacity or resource is considered in the TE routing technique to route the traffic accordingly, leading to the depletion of link buffers with build-ups at all or multiple considered paths at the same time.

### TECHNICAL FIELD

The present invention relates to the field of network communications, and, in particular embodiments, to a system and method for traffic engineering using link buffer status.

### BACKGROUND

In communications systems, traffic engineering (TE) techniques are used to optimize routing of traffic through network nodes according to network status and conditions. The TE techniques are used to improve network performance, such as by improving traffic routing distribution across network nodes and paths and hence improving resource usage. The TE techniques include calculating cost of routes (paths and nodes) and selecting appropriate routes for traffic accordingly. The nodes in a network may include buffers for buffering data, e.g., temporary buffering data before forwarding. Typically, transmit buffers (also referred to as link buffers) in the nodes suffer from build-ups of data in the buffers, for example due to channel transients or unpredicted demand change. The buffer build-ups slow data forwarding and can cause traffic congestion in the network. For services with stringent quality of service (QoS) or user quality of experience (QoE) requirements, it is necessary for data stored in link buffers to be delivered on time (without substantial delays), such as in real-time traffic services and applications. Typically, a TE engine in the network uses link buffer status from the nodes to route more traffic through nodes with less buffered data (small used buffer size) and less traffic through nodes with less buffered data (large used buffer size). However, such routing is applied on single path basis where optimization is per each path individually, which can cause buffer build-ups on other links. There is a need for an improved and efficient method for TE using link buffer status.

### SUMMARY OF THE INVENTION

In accordance with an embodiment of the disclosure, a method by a network component for traffic engineering (TE) using link buffer status includes obtaining a plurality of inputs for TE routing. The inputs include capacity and resource information for wired and wireless links in a network. The method further includes obtaining buffer status of the wired and wireless links, and reserving capacity and resource for the wired and wireless links according to the buffer status. The inputs are then modified for TE routing including the capacity and resource information according to the reserved capacity and resource. The modified inputs for TE routing accounts for the reserved capacity and resource.

In accordance with another embodiment of the disclosure, a method by a network component for TE using link buffer status includes obtaining a plurality of inputs for TE routing. The inputs include capacity and resource information for wired and wireless links in a network. The method further includes obtaining buffer status of the wired and wireless links, and calculating reserved capacity and resource for the wired and wireless links according to the buffer status. The inputs for TE routing including the capacity and resource information are then modified according to the calculated reserved capacity and resource. The routing paths including at least some of the wired and wireless links are calculated according to the modified inputs for TE routing.

In accordance with another embodiment of the disclosure, a network component for TE using link buffer status includes at least one processor and a non-transitory computer readable storage medium storing programming for execution by the at least one processor. The programming includes instructions to obtain a plurality of inputs for TE routing. The inputs include capacity and resource information for wired and wireless links in a network. The programming includes further instructions to obtain buffer status of the wired and wireless links, and reserve capacity and resource for the wired and wireless links according to the buffer status. The network component is further configured to modify the inputs for TE routing including the capacity and resource information according to the reserved capacity and resource. The modified inputs for TE routing accounts for the reserved capacity and resource.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a scenario of a network with link buffers;

FIG. 2 illustrates an embodiment of a system for traffic engineering (TE) using link buffer status;

FIG. 3 illustrates an embodiment of a method for TE using buffer status; and

FIG. 4 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

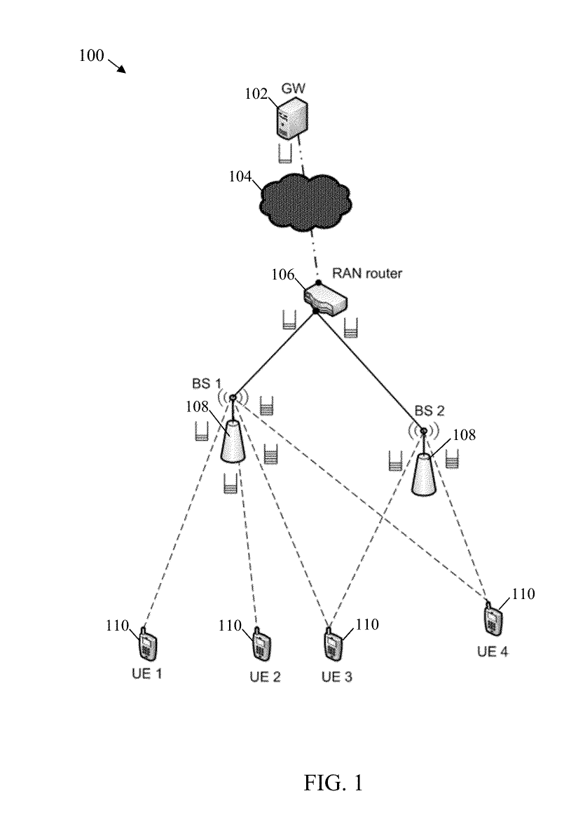

FIG. 1 illustrates a scenario of a network 100 with link buffers at the various nodes. The network 100 includes a gateway 102 for user traffic, a router 106 that routes the traffic form and to the gateway 102, a backbone or access network 104 connecting the gateway 102 with the router 106, and one or more base stations 108 (labeled BS1 and BS2) connected to the router 106. The base stations 108 communicate the traffic on wireless links to corresponding user equipments (UEs) or device 110. The nodes (gateway 102, router 106, base stations 108) of the network 100 include buffers (referred to as link buffers) for temporary buffering or queuing traffic data before transmission. Typical TE routing is aware of traffic loads at such nodes and reroutes traffic form nodes with heavy load to nodes with light loads, considering each single path at a time. Such routing can cause buffer build-ups on other links of the network.

Embodiments are provided herein for implementing TE using link buffer status to avoid such issues. Specifically, the link buffer status for each link is used to identify links with buffer build-ups. One or more of the capacity parameters (for different resources) at the links with buffer build-ups are then reserved. This is achieved by modifying the capacity/resource input parameters to the TE model according to the level of build-ups in the link buffers, as reflected by the buffer status information from the links or nodes. The reserved capacity/resource, in the form of modified input capacity parameters, is then fed to the TE engine to calculate the routing of traffic across all links and paths. As such, the reserved capacity is used to modify the input (as described below) in the TE routing technique to route the traffic accordingly, leading to the depletion of link buffers with build-ups at all or multiple considered paths at the same time. Since this multiple-path TE routing approach optimizes the routing of traffic across all or multiple considered paths simultaneously, the build-ups at light load links or nodes is avoided or reduced (in comparison to other TE techniques).

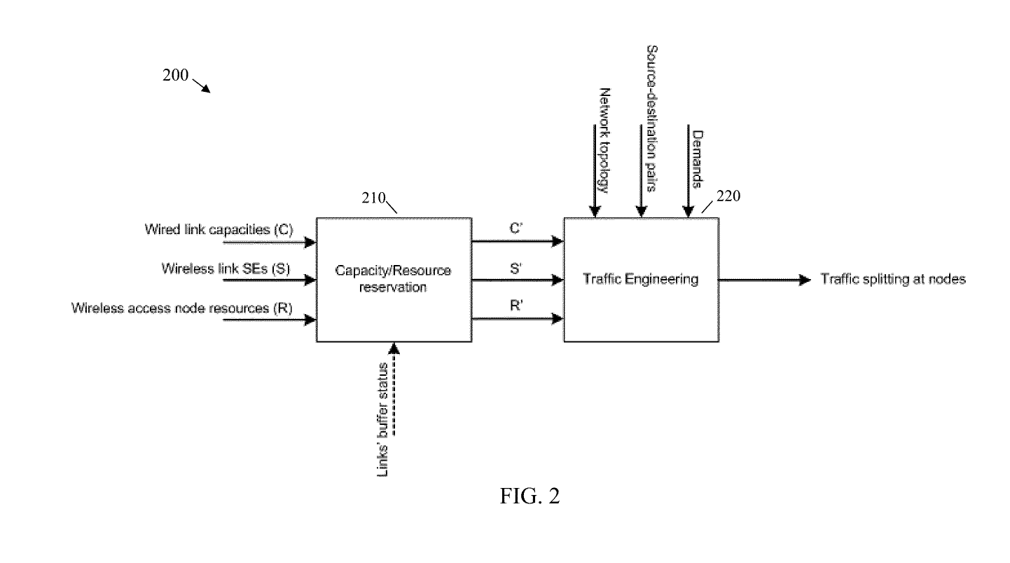

FIG. 2 shows an embodiment of a system 200 for TE using link buffer status. The system 200 includes a capacity/resource reservation engine 210 and a TE engine 220. The engines can be functions implemented via software, hardware (e.g., servers or other network components), or combinations of both. The capacity/resource engine 210 receives inputs about the capacities/resources of the links and nodes in a network, such as the network 100. The capacity inputs can include wired link capacities (C), e.g., for the links between the nodes of the network 100 (gateway 102, router 106, base stations 108). The inputs also include wireless link spectral efficiencies (SEs), e.g., for the wireless links between the base stations 108 and UEs 110, and wireless access node resources (R), such as bandwidth and other resources at the base stations 108. Additionally, the capacity/resource reservation engine 210 receives the buffer status of the links in the network, which indicates the used buffer sizes at the nodes on each of the considered links. The capacity/resource reservation engine 210 modifies (changes the value of) one or more of the capacity inputs (C, S, R) to reserve some of the capacity/resource according to the links' buffer status. For instance, reserved capacity/resource is calculated using links' buffer status information as shown below. The initial capacity input values (C, S, R) are then reduced by the calculated reserved capacity/resource to obtain corresponding updated input values (C′, S′, R′). In different implementations, e.g., according to demand and optimization target, only one of the input values, only some of the input values, or all of the input values are modified or reduced to account for the reserved capacity/resource.

After reserving the capacity/resource according to the links' buffer status, the outputs (C′, S′, R′) from the capacity/resource reservation engine 210 are sent as inputs to the TE engine 220 which processes the inputs according to available or current TE models/solutions. The TE engine 220 also receives other parameters, including network topology information, source-destination pairs for the traffic, and demands (requirements) in terms of resources, service, user, or others. These additional parameters may be additional inputs and/or condition parameters for the TE problem. The TE engine 220 processes the inputs and parameters and provides the routing results, which determines traffic splitting at nodes and links (traffic distribution onto paths). Since the inputs to the TE engine 220 and not the TE engine's algorithm are modified in the system 200, the system 200 is compatible with current TE systems. The modification to such TE systems would require adding the capacity/resource reservation engine 210 without changing the existing TE mechanism or engine. Other implementations can incorporate both the capacity/resource reservation engine 210 with the TE engine 220 as a single component or algorithm.

In an embodiment, the wired link capacities, C, obtained from the network can be modified into C′ by subtracting a reserved capacity, C₁, for each wired link, which is calculated based on links' buffer status. The links' buffer status indicates the number of bits, b₁, in each considered buffer and the buffer depletion time, t₁, for each corresponding wired link 1. Thus, the reserved capacity, C₁, is obtained as C₁=b₁/t₁, and C′=C−C₁ considering the reserved capacity for each wired link. Additionally or alternatively, the wireless access node resources, R, obtained from the network can be modified into R′ by subtracting a reserved resource, R″, for each considered wireless access node n according to the links' buffer status. The links' buffer status indicates the number of bits, b₁ⁿ, in the buffer for wireless link 1 at wireless access node n, the spectral efficiency s₁ⁿ of wireless link 1 and wireless access node n, and the buffer depletion time tⁿ for wireless access node n. Thus, the reserved resource, Rⁿ, is obtained as R^{N}=1/tⁿΣ₁b₁ⁿ/s₁ⁿ, and R′=R−Rⁿ considering the reserved resource of wireless links for each considered wireless access node. The wireless link SEs, S, can also be modified into S′ by reserving an amount of spectral efficiency for each considered wireless link. Any of the inputs can be modified or kept unchanged according to demand and requirements.

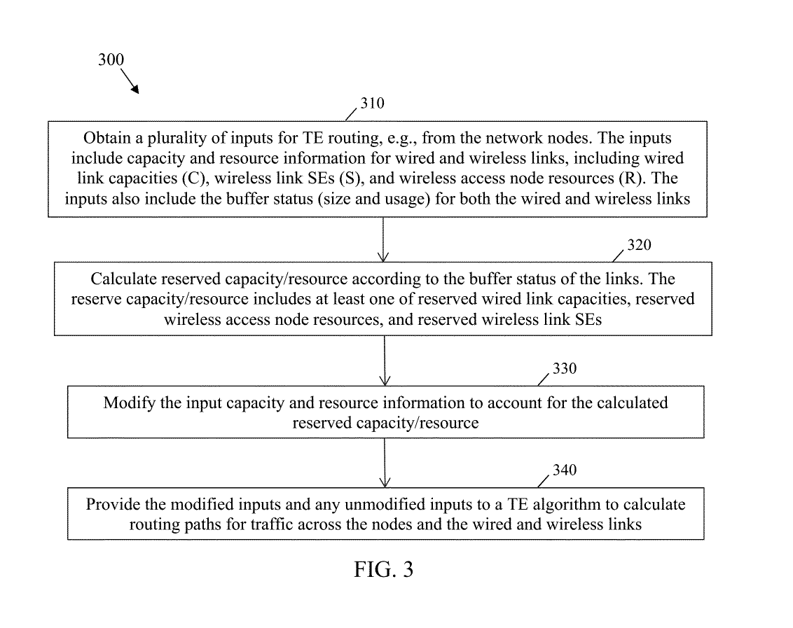

FIG. 3 shows an embodiment of a method 300 for TE using buffer status. The method 300 can be implemented using the system 200, e.g., in a network with wireless links such as the network 100. At step 310, a plurality of inputs for TE routing are obtained, e.g., from the network nodes. The inputs include capacity and resource information for wired and wireless links, including wired link capacities (C), wireless link SEs (S), and wireless access node resources (R). The inputs also include the buffer status, such as buffer size and usage, for both the wired and wireless links. At step 320, reserved capacity/resource is calculated according to the buffer status of the links. The reserve capacity/resource includes at least one of reserved wired link capacities, reserved wireless access node resources, and reserved wireless link SEs. At step 330, the input capacity and resource information are modified to account for the calculated reserved capacity/resource. For instance, the reserved wired link capacities are subtracted from the wired link capacities, C, to obtain a corresponding modified input C′. Additionally or alternatively, the reserved wireless access node resources are subtracted from the wireless access node resources, R, to obtain a corresponding modified input R′. Additionally or alternatively, the reserved wireless link SEs are subtracted from the wireless link SEs, S, to obtain a corresponding modified input S′. In the case of maintaining an input without change, the modified value can be set to the initial value, e.g., C′=C, S′=S, or R′=R. At step 340, the modified inputs and any unmodified inputs are provided to a TE algorithm to calculate routing paths for traffic across the nodes and the wired and wireless links.

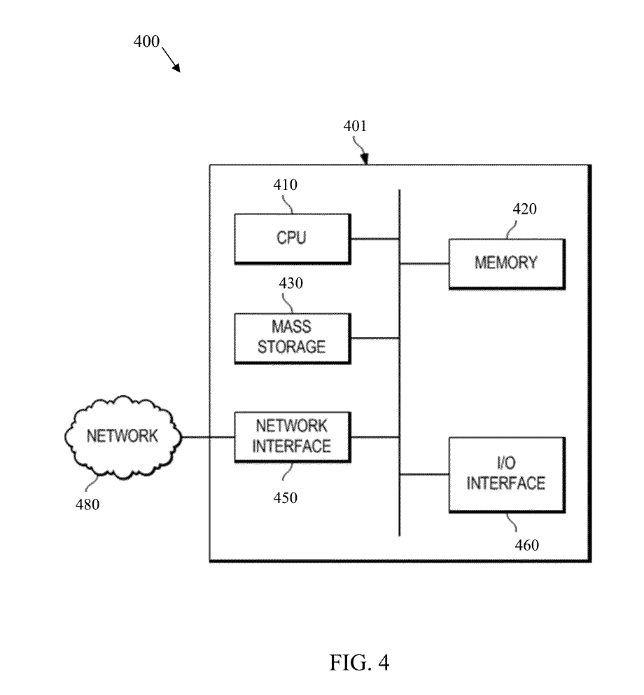

FIG. 4 is a block diagram of an exemplary processing system 400 that can be used to implement various embodiments. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 400 may comprise a processing unit 401 equipped with one or more input/output devices, such as a network interfaces, storage interfaces, and the like. The processing unit 401 may include a central processing unit (CPU) 410, a memory 420, a mass storage device 430, and an I/O interface 460 connected to a bus. The bus may be one or more of any type of several bus architectures including a memory bus or memory controller, a peripheral bus or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. In embodiments, the memory 420 is non-transitory. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a network component for traffic engineering (TE) using link buffer status, the method comprising:
obtaining a plurality of inputs for TE routing, wherein the inputs include capacity and resource information for wired and wireless links in a network;
obtaining buffer status of the wired and wireless links;
reserving capacity and resource for the wired and wireless links according to the buffer status; and
modifying the inputs for TE routing including the capacity and resource information according to the reserved capacity and resource, wherein the modified inputs for TE routing accounts for the reserved capacity and resource.

2. The method of claim 1 further comprising providing the modified inputs for TE routing to a TE function that calculates routing paths in the network including at least some of the wired and wireless links.

3. The method of claim 1, wherein the inputs include at least one of wired link capacities, wireless link spectral efficiencies (SEs), and wireless access node resources.

4. The method of claim 3, wherein the reserved capacity and resource includes at least one of reserved wired link capacities, reserved wireless access node resources, and reserved wireless link SEs.

5. The method of claim 4, wherein modifying the inputs for TE routing comprises at least one of reducing the wired link capacities by the reserved wired link capacities, reducing the wireless link SEs by the reserved wireless access node resources, and reducing the wireless access node resources by the reserved wireless link SEs.

6. The method of claim 1, wherein the buffer status of the wired and wireless links indicates size and usage of buffers at a plurality of nodes of the wired and wireless links.

7. A method by a network component for traffic engineering (TE) using link buffer status, the method comprising:
obtaining a plurality of inputs for TE routing, wherein the inputs include capacity and resource information for wired and wireless links in a network;
obtaining buffer status of the wired and wireless links;
calculating reserved capacity and resource for the wired and wireless links according to the buffer status;
modifying the inputs for TE routing including the capacity and resource information according to the calculated reserved capacity and resource; and
calculating routing paths including at least some of the wired and wireless links according to the modified inputs for TE routing.

8. The method of claim 7, wherein obtaining the inputs for TE routing includes obtaining a wired link capacity for each wired link in the network.

9. The method of claim 8, wherein calculating the reserved capacity and resource comprises calculating a reserved capacity according to the link buffer status for each wired link from a plurality of wired links in the network, and wherein modifying the inputs for TE routing includes subtracting the reserved capacity from the wired link capacity for each wired link.

10. The method of claim 9, wherein the buffer status includes a number of bits in a buffer and a depletion time for the buffer for each wired link, and wherein calculating the reserved capacity according to the link buffer status for each wired link includes calculating a ratio of the number of bits to the depletion time.

11. The method of claim 7, wherein obtaining the inputs for TE routing includes obtaining a resource for each wireless access node.

12. The method of claim 11, wherein calculating the reserved capacity and resource comprises calculating a reserved resource according to the link buffer status for each wireless access node from a plurality of wireless access nodes in the network, and wherein modifying the inputs for TE routing includes subtracting the reserved resource from the resource for each wireless access node.

13. The method of claim 12, wherein the buffer status includes a number of bits in a buffer for each wireless access node, a depletion time for the buffer, and a spectral efficiency for each wireless link of a set of wireless links for each wireless access node, and wherein calculating the reserved resource according to the link buffer status for each wireless access node includes:
calculating a ratio of the number of bits to the spectral efficiency for each wireless link of the set of wireless links;
calculating a sum of ratios for the wireless links; and
dividing the sum of ratios for the wireless links by the depletion time for the buffer for each wireless access node.

14. A network component for traffic engineering (TE) using link buffer status, the network component comprising:
at least one processor; and
a non-transitory computer readable storage medium storing programming for execution by the at least one processor, the programming including instructions to:
obtain a plurality of inputs for TE routing, wherein the inputs include capacity and resource information for wired and wireless links in a network;
obtain buffer status of the wired and wireless links;
reserve capacity and resource for the wired and wireless links according to the buffer status; and
modify the inputs for TE routing including the capacity and resource information according to the reserved capacity and resource, wherein the modified inputs for TE routing accounts for the reserved capacity and resource.

15. The network component of claim 14, wherein the programming further includes instructions to provide the modified inputs for TE routing to a TE function that calculates routing paths in the network including at least some of the wired and wireless links.

16. The network component of claim 14, wherein the programming further includes instructions to calculate routing paths including at least some of the wired and wireless links according to the modified inputs for TE routing.

17. The network component of claim 14, wherein the inputs include at least one of wired link capacities, wireless link spectral efficiencies (SEs), and wireless access node resources.

18. The network component of claim 17, wherein the reserved capacity and resource includes at least one of reserved wired link capacities, reserved wireless access node resources, and reserved wireless link SEs.

19. The network component of claim 18, wherein the instructions to modify the inputs for TE routing include at least one of instructions to reduce the wired link capacities by the reserved wired link capacities, reduce the wireless link SEs by the reserved wireless access node resources, and reduce the wireless access node resources by the reserved wireless link SEs.

20. The network component of claim 14, wherein the buffer status of the wired and wireless links indicates number of bits and depletion time of buffers at a plurality of nodes of the wired and wireless links.
